(19) United States
(12) Patent Application Publication
(10) Pub. No.: US 2011/0284110 A1
(43) Pub. Date: Nov. 24, 2011

(54) MICROFLUIDIC SURFACES AND DEVICES

(75) Inventor: John P. Gagnon, Franklin, MA (US)

(73) Assignee: WEB INDUSTRIES INC., Marlborough, MA (US)

(21) Appl. No.: 13/114,042

(22) Filed: May 24, 2011

Related U.S. Application Data
(60) Provisional application No. 61/347,545, filed on May 24, 2010.

(51) Int. Cl. F15D 1/00; B05D 5/00; B29C 59/02; B32B 3/30

(52) U.S. Cl. 137/597; 428/156; 428/600; 427/256; 264/293

(57) ABSTRACT

Microfluidic surfaces and devices are prepared by imparting a non-planar topography to the liquid flow surface.

### RELATED APPLICATION

The present non-provisional patent application claims the benefit of U.S. Provisional Patent Application No. 61/347,545 filed on May 24, 2010 and entitled “Microfluidic Surfaces,” the contents of which are hereby incorporated herein in their entirety.

The present application is directed to a method of making microfluidic surfaces as well as microfluidic and lateral flow devices employing said microfluidic surfaces.

### BACKGROUND OF THE INVENTION

The flow of fluids plays a huge role in society and in industry, how it is effected and controlled, or not controlled, as the case may be, is greatly influenced and affected by the scale of flow of concern. Macrofluidics, or the flow on a macro scale, is most often associated with free surface or channel flow, where, e.g., water follows along the path of least resistance under the influence of gravity, or pressure flow, where fluids are placed under pressure and caused to flow in a desired path. However, in most industrial applications, where flow is not of a macroscale, or if so, is of the lower end of the macroscale, other factors come into play. And, while pressure flow is still a viable solution, other methods such as capillary action and couuette flow play an important role in the control and flow of liquids.

While macrofluidic flow continues to play the predominant role in industrial, technical and commercial development; there is an ever burgeoning shift toward microfluidics, concurrent with a similar shift to micro and nano scale technologies, devices, processes, and the like. Microfluidics provide many advantages, including: smaller size; greater portability enabling development of “point of use” applications outside of a laboratory setting; require less fluid to provide a diagnostic test result; improved uniformity, specificity, precision, and accuracy of analytical tests; use of smaller amounts of expensive reagents and, in following, generate less waste: the latter being especially important in the case of hazardous chemicals and biohazards. Clearly, the art and technology of microfluidics is facilitating new advances across a broad spectrum of industrial, commercial and technical applications.

However, significant behavioral changes and issues arise in fluid flow on a micro scale: issues related to surface tension, energy dissipation, and fluidic resistance begin to dominate flow characteristics. Specifically, microfluidic flow is affected by the equilibrium of cohesive force of the fluid, the fluid's surface tension and the surface energy of the surface upon which the fluid rests. Current efforts to control microfluid flow include the use of small channels (generally on the order of 100 nanometers to several hundred micrometers in diameter), micropneumatic systems, combinations of capillary forces and electrokinetic mechanisms, electrowetting, surface energy treatments such as plasma or corona treatments and/or coatings such as hydrophilic coatings, acoustic droplet ejection, and the like. Each has their place and their limitations. For example, a number of these applications require costly equipment making them unsuited for large scale commercial and industrial applications. Others require the introduction of new chemicals to the system which, if used in specialized analytical processes, can adversely affect the test or process being run. Some, such as surface treatments and coatings, are only effective over a limited time span. Still others, like microchannels are less effective or not readily translatable to mass production, at least not in a cost effective manner.

Thus, there remains a need in the industry for a method of microfluidic control that does not require or minimizes the need for specialized equipment and processes.

Additionally, there remains a need in the industry for a method of microfluidic control that does not alter the surface chemistry or, if surface chemistry is altered, does, not require the alteration the microfluidic or lateral flow device itself, or if so, only minimally.

Finally, there remains a need in the industry for a method of microfluidic control that can be applied on a mass scale at low cost.

### SUMMARY OF THE INVENTION

According to the present invention there is provided a method for imparting microfluidic control to a surface wherein the method comprises the alteration of the topography of the surface which alteration comprises, at least in part, creation of a non-planar topography to an otherwise smooth or substantially smooth surface or portion thereof. Specifically, it has now been found that one may control or assist the control of the flow, particularly the direction of the flow, of small quantities, i.e., milli- and micro-quantities, of fluids across a surface by imparting a nano-scale and/or micro-scale non-planar topography to those areas of the surface across which the fluid flow is desired. Additionally, it has now been found that one may also control flow rates as well as preferential flow patterns across the same surface by imparting non-planar topographies of different geometries, including shape, size and/or density and/or by combining such typography alteration with other known surface alterations methodologies that likewise impact fluid flow.

According to a second aspect of the present invention there is provided a method of mass producing microfluidic devices having controlled flow characteristics as a result of the introduction of a non-planar surface topography to the fluid conveying surface of the device, which method comprises (a) creation of a master device whose surface (i) has one or more defined three dimensional images corresponding to one or more defined flow patterns to be imparted to the fluid conveying surface of the microfluidic or lateral flow device or to the stock material from which said microfluidic or lateral flow device element is to be made and (ii) is adapted to impart or transfer to that fluid conveying surface the desired non-planar surface topography and design corresponding to that flow pattern and (b) bringing said master device in contact with said fluid conveying surface so as to impart or transfer the non-planar surface topography to that surface. For example, in one embodiment, the master device may have a negative relief of the desired surface topography whereby when the master device impacts the fluid conveying surface of the microfluidic device or stock material, it imprints the positive relief of the desired non-planar surface topography into the surface thereof. Alternatively, the master device may have incorporated therein or associated therewith capabilities which can establish the desired non-planar topography in the fluid conveying surface through chemical and/or physical transformation means: for example, a chemical etchant, heat, laser ablation, laser etching, differential radiation cure, or some other method or combinations thereof.

According to a third aspect of the present invention there is provided a method of forming stock materials suitable for use as or in the manufacture of fluid conveying substrates of microfluidic and lateral flow devices. These stock materials will typically have a plurality of three dimensional images or sets of images repeated along at least one of their surfaces: the stock material to be cut so that each cut piece will contain the one or more images or set of images necessary for the end-use application. Once again, it is understood that the three dimensional images or sets of images correspond to defined fluid flow patterns of the intended microfluidic or lateral flow devices into which they are to be incorporated. The stock material may be in sheet form, especially if it is a rigid material, or it may be in rolled form. In the former, the image or design is typically imparted in a stamping method, although it is also anticipated that it may be imparted in a molding operation where the sheet is formed by a molding method and the image or negative of the image is engraved, imprinted, etc, into the wall of the mold. Where the stock material is in the form of a rolled good, especially a film, the image or pattern is typically imparted in a roll-to-roll conversion, printing (including ink jet), or imprinting method. Of course, other in-line methods may be used such as those employing laser etching whereby the film is etched as it passes one or more lasers.

According to a fourth aspect of the present invention there are provided a stock materials suitable for use as a fluid conveying substrate in microfluidic and lateral flow devices, said stock material having a plurality of different designs or images in at least one surface thereof, each design or image corresponding to a defined flow path or plurality of flow paths for a microfluidic or lateral flow device. Further, it is contemplated that these stock materials may possess or manifest or may be modified to possess or manifest differential fluid flow properties attributed to the use of two or more different surface topographies of the present teachings or a combination of one or more defined surface topographies with one or more other known surface modification techniques. For example, an area with a hydrophilic promoting pattern might be adjacent to or between two areas with hydrophobic promoting patterns, thus enhancing control and direction of the overall fluid flow. Alternatively, one may employ a single pattern with a chemical and/or physio-chemical modification, such as that induced by corona or plasma treatment.

Finally, according to a fifth aspect of the present invention there is provided microfluidic and lateral flow devices having one or more fluid conveying surfaces wherein the flow of fluid across at least one of said one or more surfaces is controlled by the presence of a non-planar surface topography in the areas of fluid flow.

### DESCRIPTION OF THE DRAWINGS

FIG. 1 is a plan view of a microfluidic device according to one embodiment of the present invention

FIG. 2A is a plan view of a portion of a microfluidic device having a microfluid pathway according to the present invention.

FIG. 2B is a cross sectional view of the portion of the microfluidic device of FIG. 2A.

FIG. 2C is an alternate cross sectional view of the portion of the microfluidic device of FIG. 2A.

FIG. 3 is a depiction of a photomicrograph image of a portion of a surface having a sinusoidal wave, rugose and/or corduroy-like pattern embossed in its surface.

FIG. 4 is a schematic representation of a surface having a cross pattern of the pattern of FIG. 3 embossed therein.

### DETAILED DESCRIPTION

As used herein and the appended claims, Applicant uses the words “image,” “design” and “pattern” synonymously in relation to the three dimensional defined flow patterns that are imparted to the fluid conveyance surfaces. A single image may correspond to a single flow path from start to end, multiple flow paths from a single starting point to multiple ending points or any two or more of the foregoing or any combination thereof: all as reflective of the microfluidic or lateral flow device into which it is to be incorporated. It is also contemplated that one could apply the pattern across the whole of the surface of the substrate or film if one is looking to affect macro-scale flow; though this is clearly not the preferred mode of use.

According to the first aspect of the present invention there is provided a method for imparting microfluidic flow control to a surface wherein the method comprises the alteration of the topography of the surface which alteration comprises, at least in part, the creation or imparting of a non-planar topography to the surface or those areas of the surface where microfluidic flow control is desired. Such topographical alteration may be, and is most commonly, applied or imparted to a smooth or substantially smooth surface or it may be applied to a non-smooth surface, including one which has applied or imparted thereto conventional microfluidic control treatments such as channeling, coating, plasma or corona treatment. Alternatively, the inverse is also possible, in that a surface created in accordance with the present teachings maybe further modified by the subsequent application of such conventional microfluidic control treatments.

Generally speaking, microfluidic control or microfluidic flow control refers to the manipulation of the flow characteristics or properties of small, milliliter or, more typically, sub-milliliter quantities of a fluid and/or the flow characteristics or properties of a fluid which is constrained to a small, typically millimeter or sub-millimeter scale flow path width. Microfluidics is especially concerned with the manipulation and control of the flow of microliter quantities of fluids, even nanoliter quantities of fluids or fractions thereof (e.g., picoliter and femtoliter quantities) and/or flow path widths, or modifications to the flow paths that are micro-scale, especially nano-scale and smaller, as found with true microfluidic devices. Microfluidic flow manipulation or control may involve or be a matter of flow direction, splitting, or flow rate or any to or all three. Specifically, in accordance with the practice of the present invention, one is able to affect, preferably control, the direction and/or speed of the flow of small quantities of a liquid across a given substrate through the use of sub-millimeter, preferably micro-sized and/or nano-sized topographic alterations.

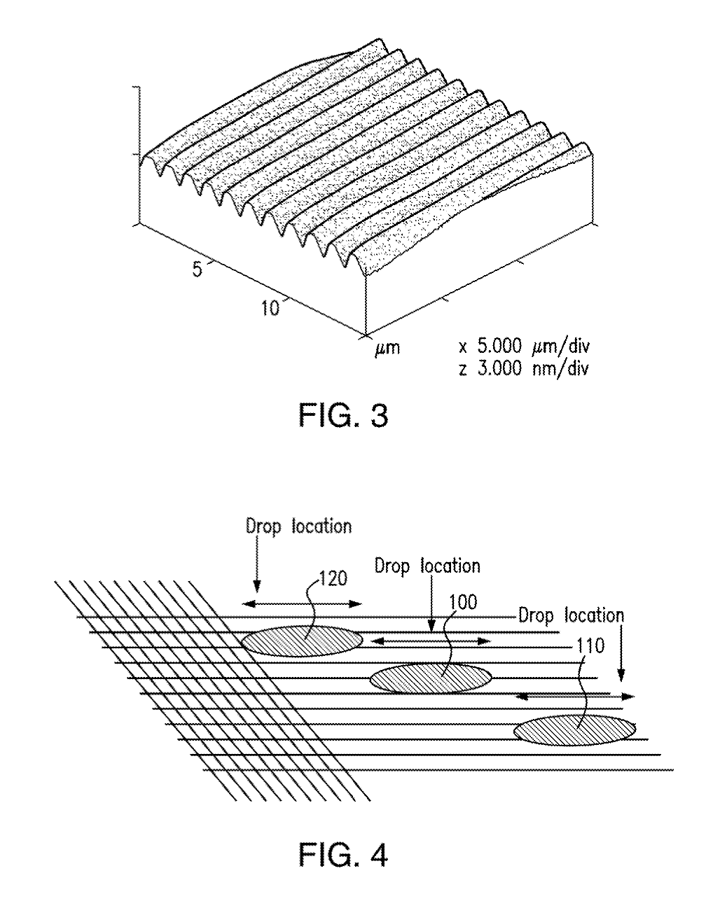

While the surface modification according to the present teachings may, and preferably do, manifest a micro-image of a corduroy type surface having a sinusoidal cross-section, as seen in FIG. 3, the flow is not a channel flow, or at least not a traditional channel flow i.e., gravitational flow constrained by channel walls, and is not limited to channel like topographies. Similarly, while one cannot dismiss the presence of some capillary action or influence, the observed flow is not a conventional capillary flow. Again, as noted above, the bulk of the fluid and fluid flow is above the three dimensional surface structures. These structure, while most often characterized herein as projections may also be recesses and, hence, the use of the term projection is intended to mean both unless inconsistent with the context in which it is used.

As will be discussed below, a number of different types of three dimensional surface projections are able to affect and influence fluid flow. Depending upon the surface tension characteristics of the fluid, the surface properties of the surface substrate itself as well as the dimensional spacing of the three dimensional surface projections, there may be fluid in the micro- and/or nano-scale channels or within and between the superstructures comprising the three dimensional surface topography; however, bulk of the fluid is above these objects, i.e., the fluid follows along the pathways, but appears to ride above the structures themselves.

Although the general discussion as set forth above and as follows is focused on microfluidic control in microfluidic devices, it is to be appreciated, and it is within the scope of the present invention, that the topography modification, as contemplated hereby and as described herein, can also be applied to somewhat larger scale applications, those involving up to a few milliliters or so of a fluid, typically a milliliter or so, so long as the influence of the topographical alterations is not overshadowed by the traditional gravitational or laminar flow of higher volumes of the liquid. In particular, the present invention is applicable to lateral flow devices which, as known to those skilled in the art, are used for a number of technical applications, especially in performing diagnostic and/or analytical tests, including, for example, tests for determining pregnancy, blood glucose, water acidity, water quality and chemical balance, and the like; bioassays, as in DNA analysis and immunoassays, and other research efforts. In general, lateral flow devices tend to comprise one or more surfaces having one or more reagents and/or indicators associated therewith which typically provide a color, electromechanical, or electrical response indicative of the absence or presence of a material in the test fluid and/or of its concentration or of a property of the fluid being tested, e.g., alkalinity, conductivity, photochromatographic response, etc.

For convenience, rather than refer to both microfluidic devices and lateral flow devices throughout this specification and the appended claims, as used herein and in the appended claims, unless otherwise stated, and as context allows, the term “microfluidic device” is intended to mean both true microfluidic devices and lateral flow devices as defined above. Similarly, “microfluidic flow” is likewise intended to mean both micro-fluidic and more voluminous lateral flow.

Microfluidic control as contemplated by the present invention is accomplished by imparting to the substrate surface a “non-planar topography.” As used herein and in the appended claims, the concept of a non-planar topography means that the surface or topography of the substrate has been altered in a three dimensional manner whereby the surface area of the area so modified is increased by at least 10%, preferably by 20% or more, more preferably at least 30% or more. Indeed, the present invention allows for surface area increases of up to 50% or more, e.g., 60% to 70% or more, and said increased surface area is due, in whole or in part, to the creation of three dimensional alterations in the surface of the substrate. Although the non-planar topography of the present invention can be channel-like in appearance; again, these structures are on a micro- and nano-scale whereby fluid flow is not gravitationally motivated nor constrained by side-walls of the channels; but is motivated, as noted below, by an alteration in the surface tension equilibrium between the fluid and the substrate, especially the modified substrate. In this regard, to the naked eye, perhaps even to a magnifying glass assisted eye, the surface will have a texture differentiation, i.e., will appear duller or less reflective than the untreated areas, but will not visibly show the distinct channels in the substrate as would be apparent with a traditional channel. However, under a microscope or so, the image will show the sinusoidal wave pattern, corduroy or rugose type image. Furthermore, it is to be understood that while traditional channels may also be incorporated into the surface of the substrate being modified, at least a portion of the substrate will have the non-planar topography of the present invention. This may be in areas adjacent to the channels or, preferably, may be within the channels themselves such that at least a portion, if not the entire, floor and/or walls of the traditional channel has a non-planar topography according to the present teachings. For example, the substrate may have discrete channels cut, etched or embossed into the surface wherein the floor and/or walls of these channels has a micro- or nano-sized corduroy pattern or texture.

As noted above, the topography to be imparted to the fluid conveying surfaces of the present invention is three-dimensional and may be in the form of a defined or random pattern of structures or elements which recess into or protrude from the normal plane of the substrate surface or both. The imparted topography may comprise a single type or shape of 3-D element, e.g. chevrons, hemispheres, pillars, tilted pillars, a rugose surface, pyramids, ridges, diamond shapes, etc. or a combination of such shaped elements. Alternatively, the three dimensional topography may not have any defined shape, characteristics or pattern within the flow path, similar, if you will, to the Grand Canyon. For example, one may use a laser, an etching technique, or any other appropriate method to form random recesses in the substrate surface along the proposed flow path so as to cause a cratering or pock-marked effect, a roughened surface of uneven hills and valleys, and the like. In this regard, it is to be appreciated that the three dimensional structures may be projections extending from the surface of the substrate or the floor of a channel or impression in the substrate or they may be recesses themselves, extending into the surface of the substrate: in essence, positive and negative images. Preferably, the topography mimics a corduroy or rugose pattern or texture wherein the channels are linear and/or curved, depending upon the desired flow pattern, and the cross-sectional image is of a repeat sinusoidal wave.

As noted elsewhere in this specification, the specific topography and structures which embody or make up the topography will depend, at least in part upon the fluid to be applied to the microfluidic surface as well as the nature or type of substrate on which the microfluidic pattern is applied: all of which relates to the equilibrium between the fluid and the substrate surface. The selection of structures will also depend upon the specific flow property to be imparted to the substrate surface and can include structures that increase flow, decrease flow, change flow direction, or impede flow. It is also contemplated that any given flow path may employ different topographies to different areas of the same flow path to alter flow rates, to alter flow direction or to set the bounds of the flow path, or any or all three.

Following on the foregoing, the dimensions, especially the amplitude or height, of the three dimensional structures as well as their frequency or spacing will vary from one fluid to another and, perhaps less so, from one substrate to another. Generally speaking, for water and certain aqueous based fluids, and perhaps those fluids manifesting similar viscosities and surface tension characteristics, three dimensional structures of varying dimensions have been found or are believed to be suitable. For example, the three dimensional structures within the flow path may have a height or amplitude (base or valley to peak) of up to 50 μm, even 75 μm, or more, but are most typically within the range of from 100 nm to 25 μm, preferably from 250 nm to 10 μm, most preferably from 500 nm to 3 μm. Similarly the spacing or gap between projections can be up to 500 μm, even 750 μm, or more, but are most typically within the range of from 100 nm to 250 μm, preferably from 500 nm to 50 μm, most preferably from 800 nm to 10 μm. In the case of those topographic modifications in the form of corduroy or rugose surfaces, while the foregoing dimensions are applicable here as well, it is generally preferred that the height or amplitude of the waves or wave-like structures (valley to peak) will be from 100 nm to 10 μm, preferably from 500 nm to 5 μm, most preferably from 1000 nm to 3 μm with a peak to peak separation of from 300 nm to 15 μm, preferably from 1000 nm to 8 μm, most preferably from 1500 nm to 3 μm. Finally, the length and width or, as appropriate, the diameter of the three dimensional structures, particularly as discrete structures, will vary widely as well depending, in part, upon the desired flow characteristic sought. Structures whose dimensions are consistent with, perhaps even a bit larger than, the aforementioned ranges for the spacing of the structures are suitable and contemplated. Typically, though, the discrete structures will be of a similar size to or smaller than the spacing between such structures. However, in the case of “linear” structures, such as the wave and rugose patterns, the lengths of the structures are or can be as long as the fluid pathways themselves. In this context, the term linear refers to the continuous nature of the structure, e.g., a ridge or set of ridges, though the structures will extend along and follow the fluid pathway which may bend or curve.

Amplitude and spacing are also affected by the methodology by which the three dimensional images are produced; though perhaps a more important factor in setting the amplitude and spacing is the intended end use application, specifically and especially, the surface tension and surface energy characteristics of the specific fluid to be acted upon and of the substrate surface, respectively. For example, photolithographic techniques will provide amplitudes of up to 3 μm and spacing of up to 10 μm whereas mechanical methods will support much large, structures and wider spacing, up to 50 μm or more. Simple trial and error, following the teachings of the present specification, can be used to find the optimum for the specific fluid and/or substrate and/or microfluidic device.

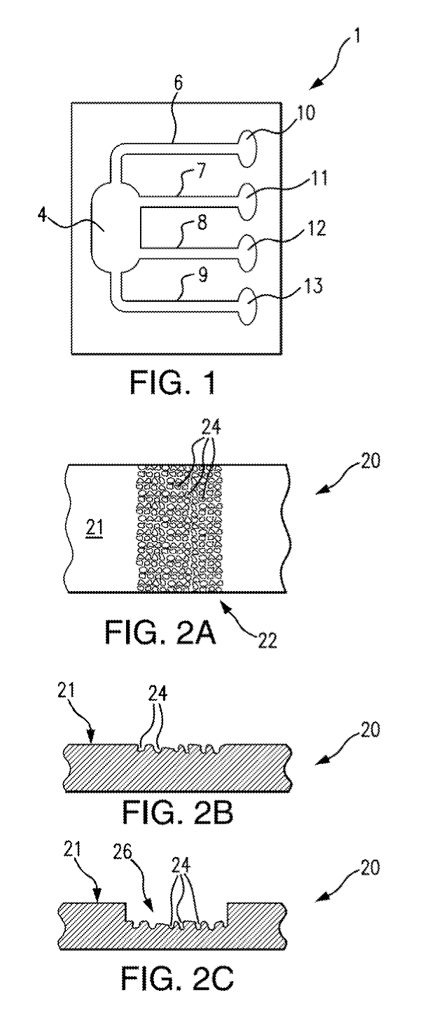

The altered surface topography may be applied to the whole of the substrate surface, but is most preferably and typically applied to only a portion thereof. It may be as a single patterned area or a series of patterned areas, which may be parallel and/or intersecting; radially oriented, like spokes from a hub; or any other pattern or combination of patterns needed for the flow path of the end-use microfluidic device. Alternatively, it may comprise a plurality or repeat pattern of discrete patterned areas, which may be single defined patterns or a series of patterned areas. This is especially so for stock materials which are subsequently cut for making individual microfluidic devices. To aid in an understanding of the types of patterns possible, reference is made to FIG. 1. Specifically, as seen in FIG. 1, a microfluidic surface (1) for use in an analytical process for blood serum has a fluid well (4) where the blood serum is applied to the surface of the microfluidic device. Extending from the well are four fluid pathways (6, 7, 8, 9) having a non-planar topography, each pathway ending in an analytical cell (10, 11, 12, 13, respectively) which may or may not, have a non-planar topography. So long as the analytical method is not adversely affected by its presence, the analytical cell will preferably have the non-planar topography and/or will be a recess in the substrate surface whose depth is greater than the depth of the fluid pathways.

To assist in flow direction, preferential flow, and/or alter the speed or rate at which the fluid flows along the flow path; one may alter the density of the 3-D elements in the flow pathway and/or increase or decrease the size and/or depth or height of the 3-D elements. Another aspect affecting flow rate and direction is the substrate surface itself: this is particularly true for water and water-like or water-based fluids. In these instances, if the substrate is hydrophilic, increasing the surface area will increase flow across that surface area by changing the equilibrium balance between the surface of the desired flow direction versus non-desired flow directions and the surface energy of the fluid being directed. Increasing the density of the 3-D elements, and hence the surface area along the pathway will increase the flow rate and/or ensure flow direction. On the other hand if the substrate is hydrophobic or of low surface energy, one can use the greater surface area to effectively push the water along the flow path to the exclusion of non-desired directions, as the hydrophobic surface will tend to repel the water.

Again, referring to FIG. 1, as indicated, flow paths 6 and 9 are longer than flow paths 7 and 8. Assuming each flow path has the same topography and width one would expect that a fluid travelling from the fluid well (4) would reach analytical cells 11 and 12 before fluid reaches analytical cells 10 and 13. If one wanted to ensure that the fluid reaches each analytical cell at the same or nearly the same time, one may increase the density of the 3-D elements in flow paths 6 and 9; use two different types of surface alterations in the two different length pathways, e.g., use a corduroy pattern in one and a pillared pattern in the other; use a dual surface modification in one set of pathways, e.g., use a combination of the present surface alteration and a conventional surface alteration, as discussed below.

Those skilled in the art will also appreciate that where soft lithography and other methods that build the topography on the substrate surface are employed, as described further below, one may create the topography out of a material that is of a different hydrophilicity and/or surface energy than the underlying substrate. In this way, the 3-D elements will either help push or pull the fluid (which may or may not be water or aqueous based) across the fluid conveying substrate surface and/or help overcome the impact of a substrate having too high or too low of a hydrophilic characteristic and/or surface energy. This could be especially important in those limited circumstances which require the use of a specific material as the substrate which material does not have the desired or proper hydrophilicity or surface energy characteristics. For example, a given end-use application may be subject to high temperatures and/or a corrosive environment which is not conducive to the use of a material having a more favorable or appropriate hydrophilic or high surface energy characteristic.

The present invention may be employed with essentially any substrate composition, and is particularly suited for glass, metal and metal foils, thermoplastic and polymer films, thermoset and resin based materials, and ceramics. However, in its preferred and most commercially viable, from an economic perspective, the present invention is especially suited for use with those metals, metal foils, and polymer films and sheets to which images can readily be transferred from a stamping or embossing type process or into which the image can be molded in a molding or forming process. The selection will depend upon the utility or application to which the microfluidic substrates are employed. For example, a one time, disposable device, such as a blood serum analytical test kit, will be made of the lowest cost material which can be mass produced and which is suitable for the given application: in this case most likely a commodity plastic sheet or film. Other devices that are to be reused, e.g., an analyte sample cell or the analyte flow path element of analytical equipment like spectrophotometers, NMR and the like, may be made of glass or metal.

The surface topography as required by the present invention may be imparted, directly or indirectly, into the substrate surface by any of a number of known methods for surface alteration. For example, one may alter an existing substrate surface by, among other methods, soft lithographic methods including microcontact printing, replica molding (REM), microtransfer molding (μTM), microwelding in capillaries (MIMIC), and solvent assisted micromolding; by photolithographic methods including phase shift photolithography, photolithography, projection photolithography, extreme UV (EUV) lithography, soft X-ray lithography, proximal probe lithography, e-beam writing, focused ion beam (FIB), and the like; as well as by a number of other mechanical and/or chemical methods such as laser ablation, blasting, grit blasting, cast molding, physical micromachining, electrochemical micromachining, pad printing, screen printing, stereolithography, laser induced deposits, micro-embossing, acid etching, ion milling, and the like. Those skilled in the art will readily recognize that these techniques vary in terms of their application, some being especially suited for direct application to the substrate whose topography is to be altered and others where a master mold, stamp, mask or die is initially manufactured and subsequently employed for transferring, imprinting, or building the pattern on or in the substrate surface. All of these methods, as well as others known for altering surface topography, are well known, though not for the purpose and in the manner set forth here, and may be readily adapted by those skilled in the art to accomplish the controlled topography called for by the present invention.

The specific method to be employed depends upon a number of factors including whether the alteration in the topography is to be built upon or recessed into the existing substrate surface, is to be molded into the substrate surface as the substrate itself is being formed, or is to be transferred from a master to the article or a stock material. It will also depend upon the composition and surface tension characteristics of the substrate to be altered and the desired or needed flow modification. For example, as mentioned above, if one desires to add hydrophilic features to an otherwise hydrophobic or poorly hydrophilic substrate, one may need to build the topography using a hydrophilic material. If one wants to mass produce an element having the desired topography, it is easier and less costly to employ methods that work from a master mold, die, or stamp and which can impart the topography in a large batch type or continuous operation. On the other hand, if one needs a custom design or flow path pattern or employs a material that is not conducive to mass production, then one may opt to use a method where an original topography is imparted to the substrate surface. For example, one may employ laser ablation, e-beam writing, micromachining, grit blasting, and the like. Again, those skilled in the art, having the benefit of the teachings of the present application will readily recognize and be able to apply or adapt those techniques best suited for their particular need and application.

Selection of the method employed may also be influenced by or affected by the chemical composition of the substrate selected. Certain substrates may be better suited to one process versus another. For example, embossing or another imprinting type method may not be appropriate for an elastomeric material whose resiliency is such that the imprint is quickly lost as the elastomer or elastomeric polymer regains its original shape and, hence, surface characteristics. Similarly, substrates made of certain low surface energy polymers may not be suitable for those processes which rely upon building the topography upon the surface thereof owing to poor adherence of the materials or “inks” used to build the three dimensional topography to the underlying substrate surface. For example, low surface energy polyolefins may be better suited to processes wherein the topography is imparted into the surface rather than built upon the surface. Similarly, glass and metal substrates will oftentimes require or employ processes not suitable for plastic substrates, as will be appreciated by those skilled in the art.

Additionally, the selection of the method chosen will also depend upon the topography or shape of the substrate surface to be treated. For example, if the substrate itself is curved, arched, wavy, etc., one needs a method that is capable of following the contours of the substrate. In this respect, soft lithographic methods, especially those wherein an elastomeric master is made and then used to transfer or print the pattern to the substrate, may be more appropriate. Similarly, if the surface modification is to employ a combination of a conventional microfluidic technique, such as channeling, with the topographic method of the present invention, then molding or embossing methods may be more suitable. Here, the combination of channels with the 3-D elements therein can be imparted simultaneously to the substrate surface.

Attention is now drawn to FIGS. 2A, 2B and 2C. Specifically, FIG. 2A shows a plan view of a portion of a substrate (20) having a flow path (22) across its surface. As seen by FIGS. 2A and 2B, the flow path is defined by a plurality of random sized and positioned craters (24) in the substrate surface (21). Another embodiment, one which employs a conventional technique with the process of the present invention, a dual topographic alteration, is shown in FIG. 2C. In this particular embodiment, the conventional alteration is the presence of a defined channel (26) cut in the substrate surface (21). However, here, the channel is modified to incorporate a plurality of random sized and positioned craters (24) according to the present invention in the bottom surface of the channel. Though shown and described in terms of craters wherein the continuous surface in and amongst the structures is coplanar with the surface of the substrate, it is more preferable that continuous planar surface of the pathway be recessed into the surface of the substrate such that the three dimensional structure protrude upward and have a peak surface that is substantially co-planar with the substrate surface. In this regard, in the embodiment shown in FIG. 2A, the craters would be pillar and, as more clearly shown in FIG. 2C, the pillars would stand up from the floor of a recessed area in the substrate. Alternatively, the same effect may be generated by building the pillars on the surface of the substrate: the key result desired to create a continuous pathway between the projections.

As discussed in the preceding paragraph and elsewhere, it may be desirable and, depending upon the surface energy characteristics of the substrate and/or the fluid, necessary to provide a conventional surface alteration to the substrate surface as well. Depending upon the nature of the conventional surface modification technique to be applied, one may either perform the conventional surface modification to those areas of the substrate to which the non-planar surface topography of the present teachings have been applied or, conversely, one may first apply the conventional surface alteration to the substrate and then apply the present surface topography modification of the present teachings. For example, if one is going to do channeling, it is preferred, if not critical, to form the channels first or concurrently with the topographical modification as channeling after will remove the micro- or nano-scale modifications. On the other hand, corona treatment is preferably performed after so as to ensure that the surfaces of the topographical modifications are likewise treated.

Preferred conventional surface alteration techniques that may be employed in the practice of the present invention are those involving surface treatments or coatings, i.e., those which alter the chemistry or chemical properties of the surface. For example, one may employ plasma or corona treatments or apply coatings of given hydrophilicities, before or, preferably, after topographic alteration according to the present invention. In particular, one may desire to apply a hydrophobic or less hydrophilic coating to those surfaces of the fluid conveying surface outside of the flow paths of a hydrophilic or more hydrophilic substrate, respectively, so as to assist with flow path control. One could even use coatings of different hydrophilicity within the flow paths to alter the flow rate in one path versus another (different coating in different flow path) or within the same flow path to alter the flow at different points of the flow path.

It is believed that the use of dual topographic alterations will further enhance, if not have a synergistic effect on, microfluidic dynamics. For example, looking again at FIG. 1, by employing a dual topographic alteration in flow paths 6 and 9, one may achieve the simultaneous or near simultaneous arrival of fluid from the fluid well (4) at each of the analytical cells (10, 11, 12, 13). Similarly, the use of surface treatments may also assist in greater control of flow rates. However, it is to be appreciated that the use of such treatments suffers from the gradual loss of the coating or treatment through repetitive use; thus, limiting its life: a factor that is not an issue with the topographical alteration of the present invention. Furthermore, such treatments may, depending upon the end-use application, interfere with or introduce a variable or trace contaminant in the fluid being analyzed owing to the erosion and/or dissolution of the surface treatment, especially coatings, into the fluid. On the other hand, the use of properly sized channels may introduce capillary action and more defined directional control as compared to the topographic alteration by itself: a factor that could be especially important where the channel or reservoir of fluid is accidently flooded and the effect of the surface topography modification is overwhelmed or masked due to the gravitational effect on the excess fluid.

While, as noted, the process of the present invention is applicable to the manufacture of microfluidic surfaces on a one-by-one basis, it is especially applicable to mass production on a batch or continuous basis. In this respect, according to a second aspect of the present invention there is provided a method of mass producing microfluidic surfaces, especially devices, having controlled flow characteristics as a result of the introduction of a non-planar surface topography to the fluid conveying surface of the device, which method comprises (a) creation of a master device whose surface (i) has one or more defined three dimensional images corresponding to one or more defined flow patterns to be imparted to the fluid conveying surface of the microfluidic or lateral flow device or to the stock material from which said microfluidic or lateral flow device element is to be made and (ii) is adapted to impart or transfer to that fluid conveying surface the desired non-planar surface topography and design corresponding to that flow pattern and (b) bringing said master device into contact with said fluid conveying surface so as to impart or transfer the non-planar surface topography to that surface. For example, in one embodiment, the master device may have a negative relief of the desired surface topography whereby when the master device impacts the fluid conveying surface of the microfluidic device or stock material, it imprints the positive relief of the desired non-planar surface topography. Alternatively, the master device may have incorporated therein or associated therewith capabilities which can establish the desired non-planar topography in the fluid conveying surface through chemical and/or physical transformation means.

Those skilled in the art will readily recognize that many of the aforementioned processes can be adapted for mass batch or continuous processing. This is especially so for soft lithographic techniques where a master is formed having the positive or relief of the desired topography and the master is then used to prepare elastomeric molds or stamps having the negative image in their surface which molds or stamps are then used to apply a curable “ink” to the given substrate surface, thereby building the desired pattern or topography on the substrate surface. Alternatively, the master, itself, may be used to microprint an acid or etchant to the substrate surface which is allowed to sit before being washed away and/or neutralized.

An especially preferred method for the mass production of the microfluidic surfaces, either as articles, elements or stock materials, is embossing wherein a master is formed which has the relief of the desired topography, which master is brought into contact with the substrate surface to be altered, typically under pressure and/or heat and pressure, wherein the relief is imprinted into the surface of the substrate. The master may be in the form of a sheet, for one-by-one stamping of corresponding sheets of the substrate or, preferably, in the form of a roll, which continuously applies the topography to a “continuous” film or sheet of the given substrate. This method is especially applicable to ductile substrates, including those made of metal foils, ductile metals, and certain, non-resilient, yet ductile plastics and polymers, whether in stock sheet or film form. This method also applies to thermoplastic materials where heat is used to soften the plastic so as to allow the transfer of the desired non-planar topography into the transfer medium. In addition, the method can to used to impart the non-planar topography into a non-cured coating such as a UV cure coating and having the topography cured in place during or just after the transfer process.

Masters and their manufacture are well known in the print and embossing industries. Those skilled in the art will readily appreciate the means to adapt the production thereof for use in the practice of the present invention using the various techniques described. In essence, the methods are the same: it is the scale and/or outcome or, more specifically, the nature of the pattern that is new and different. For example, holography uses the same or very similar methodologies, but not with the defined patterns and characteristics as required of the present teachings.

Where the master is in the form of a sheet, the master is or a plurality of masters are affixed to one or both faces of a press and the substrate to be acted upon placed between the opposing faces. The press is then activated and the opposing faces forced towards one another, with or without heat, to imprint the topography into one or both surfaces, as appropriate, of the substrate. Depending upon the nature of the assembly and the ease of the image transfer, it is also possible to employ a conveyor that passes the substrate surfaces below a plate press having the master facing the conveyor. As the substrate passes below the plate press, the plate press is activated to impact upon the substrate, with or without stopping of the conveyor.

Most preferably, the master is in the form of a master roll which is incorporated into a traditional roll-type embossing apparatus with a counter face opposing the roll at the point of contact of the roll with the substrate. The counter face prevents the substrate from backing off from the master at the point of impact so as to ensure that the pattern is imprinted into the substrate. The counter face may be either a flat surface, in which case the substrate slides across the surface as it progresses past the master roll, or it may be a counter roll, rotating in the opposite direction, thereby assisting in the advancing of the substrate past the master. The latter creates a pinch roller setup. Both types of apparatus will work with rigid or stiff sheets, but are especially suited for roll-to-roll conversion of films and foils. When thermal energy is used to facilitate the transfer of the desired non-planar topography, the pinch roll set up has temperature control to maintain the optimum transfer conditions. If the transfer of the desired non-planar surface topography is imparted into an energy cured coating, the curing method is applied during the image transfer or just after the image transfer. In both cases either the master roll or the counter face may have heating elements or means associated therewith that heat and soften the polymer film or cure the curable coating.

The fluid conveying stock materials produced in accordance with the teachings of the present invention are suitable for use as or in the production of a multitude of microfluidic devices. These stock materials have a plurality of repeat designs in at least one surface thereof corresponding to the desired flow pathway for the microfluidic device into which they are to be incorporated. The flow pathways themselves, or at least a portion thereof, have a non-planar topography as described above for directing and/or controlling the flow of fluid across the surface thereof. The design of the device may intend to have the fluid directed either within or without capillary channels. These stock materials may be in sheet form, especially if it is a rigid material, or they may be in roll form. In the former, the design is typically imparted in a stamping method; whereas, in the latter, the pattern or topography is typically imparted in a roll-to-roll conversion, embossing, printing, or imprinting method.

These stock materials may be employed in the manufacture of any number of industrial and technical applications. Applications incorporating microfluidics are emerging rapidly in manufacturing, in research, in medicine, and the like. Thus, as more and more technologies evolve to micro- and nano-scale manufacture and applications, there is an even greater need for microfluidic devices to participate in those processes and applications. For example, in genetic research and engineering and in industrial genetics, transport of aliquots or materials to be analyzed, including individual DNA strands, requires microfluidic methods. Analytical equipment for testing for the presence of small and trace quantities of elements, compounds, and the like likewise requires microfluidic transport means.

In medicine there are a multitude of applications for microfluidic devices, some of which necessitate single use, disposable articles and other that require high tolerance, specialty materials. For example, with respect to the latter, as micro- and nano-sized liquid medicament delivery devices are developed, microfluidics will be important for charging or adding the liquid medicament to the micro- or nano-article carriers. Similarly, nano-articles could be used to deliver radioactive materials to targeted organs, and, again, microfluidics will be important for charging those articles. On the other hand, the use of microfluidics presents huge potential in the area of medically oriented diagnostic testing. For example, as discussed above, application of a droplet of serum or blood to a single spot on a test strip or other substrate having the microfluidic properties of the present invention will allow one to perform multiple tests on the same sample using the same test strip. Referring to FIG. 1 again, each test cell may have a reagent that is an indicator for a different material or test or may be an indicator for the same material or test but of a different sensitivity to a specific chemical so that one is able to more accurately determine the concentration of that chemical in the blood.

Furthermore, while, as noted above, the teachings of the present invention are equally applicable to lateral flow devices, it is also to be appreciated that the teachings of the present invention will facilitate the evolution and downsizing of lateral flow devices to true micro-fluidic devices as well as improve the performance of existing lateral flow devices. For example, many lateral flow devices do not control the flow or quantity of the fluid that comes in contact with the indicator or reagent treated surface. Thus, since many tests are quantity dependent, too little fluid and a false result may arise. Too much fluid and the color indicator tends to bleed: thereby necessitating prompt readings. Either way, such test strips are less accurate than attainable with a more controlled analysis. However, lateral flow devices as well as microfluidic devices according to the teachings of the present invention have greater control of the amount of fluid passing or reaching the indicator or reagent such that one can more precisely coordinate the amount of reagent, and hence sensitivity of the test, with the quantity of fluid that is to come in contact therewith so as to enable more accurate readings.

### EXAMPLES

A number of non-planar surface topography modifications, with and without a dual mode surface modification, were made to various substrates and the effect thereof on various aqueous fluids were evaluated. Based on these experiments, the phenomenon of directional water flow across defined pathways was observed. The surface characteristics, especially surface energy and topography, and the fluid surface tension characteristics affected performance, as did the secondary mode surface modifications. Generally speaking, it was found that higher amplitude and wider spacing provided an enhanced effect as compared to similarly modified surfaces with smaller amplitude and more densely spaced surface modifications. However, it is believed that further work will show that a maximum will be reached beyond which the effect is thereafter diminished.

In the following examples, atomic force microscopy (AFM) was used to measure and confirm the transfer of the embossing patterns. Fluid flow was determined by placing 1 μl droplets of the select fluid at five evenly spaced intervals on the modified and unmodified surfaces, first ensuring that the substrate was flat to avoid any gravitational impact. Droplets were placed carefully to avoid influencing fluid flow. Digital calipers were then used to measure the distance of any fluid flow on each droplet and the average of the five droplets determined and recorded. All results are presented in inches.

### Example 1

### Linear Flow on Nickel Shims

Sinusoidal wave patterns were produced in the surface of nickel shims using conventional imaging techniques. Specifically, a curable photoresist coating was applied to a glass substrate and subjected to laser imaging using a split laser beam which is manipulated to re-intersect at the coated substrate surface. The laser beams will alternately cancel out each other's energy or amplify each other's energy across the surface of the nickel substrate resulting, in “lines” in the photoresist corresponding to the greater or lesser exposure. The photoresist coated surface is then developed and washed to remove the undeveloped photoresist. The surface is then subjected to electro-plating with nickel to form shims having the negative of the original formed surface topography. A positive shim is likewise prepared by electro-plating of the negative shim. The lines manifest themselves are linear grooves or linear ridges, depending upon whether one, is using the positive or the negative shim, respectively. The frequency between the lines, and which gives the surface the corduroy effect, will depend upon the frequency of the laser used and the angle of the convergent beams as they expose the photo-resist. The amplitude of the lines will depend upon the length or duration of the exposure, the thickness of the photoresist, and the development conditions, all as known in the art of master production. The development conditions will also affect the shape of the resulting topography with longer development times resulting in steeper shaped grooves or, as appropriate ridges.

Various nickel shims were prepared as generally outlined above and tested. The surface topography realized was as depicted in FIG. 3, with frequencies varying from 0.5-3.0 μm (peak to peak) and amplitudes varying from 0.5-2.0 μm (valley to peak). Variable fluid flow of up to 0.5 inch (1.25 cm) and more was observed with droplets of just 1 μl of select aqueous fluids when placed in the topographically modified surfaces. A representative sampling of the different samples evaluated and the results attained thereby with three different liquids are presented in Table 1. The three liquids tested were A—Deionized water (DI), B—10% isopropyl alcohol (IPA) in DI and C—40 IPA in DI.

TABLE 1

| | | | | Planar | Ob- | |
|---|---|---|---|---|---|---|
| | | | | Surface Sym- | served | |
| | | | | metrical | Linear | |
| Sample | Modulation | Modulation | | Fluid | Fluid | Net |
| # | Frequency | Amplitude | Fluid | Spread | Spread | Effect |
| 1 | 1.5 μm | 1.2 μm | A | 0.070 | 0.315 | 0.245 |
| 2 | 1.5 μm | 1.2 μm | B | 0.090 | 0.415 | 0.325 |
| 3 | 1.5 μm | 1.2 μm | C | 0.125 | 1.142 | 1.017 |
| 4 | 1.5 μm | 0.8 μm | A | 0.070 | 0.235 | 0.165 |
| 5 | 1.5 μm | 0.8 μm | B | 0.090 | 0.435 | 0.345 |
| 6 | 1.5 μm | 0.8 μm | C | 0.125 | 1.115 | 0.990 |
| 7 | 1.0 μm | 1.2 μm | A | 0.070 | 0.438 | 0.368 |
| 8 | 1.0 μm | 1.2 μm | B | 0.090 | 0.625 | 0.535 |
| 9 | 1.0 μm | 1.2 μm | C | 0.125 | 0.938 | 0.813 |
| 10 | 1.0 μm | 0.8 μm | A | 0.070 | 0.375 | 0.305 |
| 11 | 1.0 μm | 0.8 μm | B | 0.090 | 0.500 | 0.410 |
| 12 | 1.0 μm | 0.8 μm | C | 0.125 | 0.875 | 0.750 |
| 13 | 0.5 μm | 1.2 μm | A | 0.070 | 0.250 | 0.180 |
| 14 | 0.5 μm | 1.2 μm | B | 0.090 | 0.375 | 0.285 |
| 15 | 0.5 μm | 1.2 μm | C | 0.125 | 0.563 | 0.438 |
| 16 | 0.5 μm | 0.8 μm | A | 0.070 | 0.188 | 0.118 |
| 17 | 0.5 μm | 0.8 μm | B | 0.090 | 0.313 | 0.223 |
| 18 | 0.5 μm | 0.8 μm | C | 0.125 | 0.500 | 0.375 |

As seen from the results presented in Table 1, the placement of the droplet on the unmodified surface resulted in a symmetrical fluid spear whereas the placement of the droplet on the modified surface resulted in a linear flow along the topographically modified surface. These results show the surprising and marked ability of the nano-scale surface topography to direct and influence fluid, particularly microfluid quantity, flow. These results also show an enhanced flow behavior with features of higher amplitude and wider spacing. Similarly, the selection of fluids having lower surface tension also enhanced the flow effect.

### Example 2

### Linear Flow on Nickel Shims with Cross Grating

Nickel shims were prepared as in Example 1 except that a cross-grating was applied. The cross-grating was attained by use of a two-step photoresist curing process wherein the nickel substrate was first exposed as in Example 1 and then the beam to substrate surface angle changed and a the substrate exposed again. This resulted in sample plates that had areas of linear gratings and double gratings superimposed on each other. FIG. 4 presents a schematic of the nickel substrate with the cross-grating topography. Though the pattern is depicted as spaced lines, the actual topography is as shown in FIG. 3; thought the area corresponding to the cross grating would have the same appearance as intersecting waves. The specific samples evaluated and the results attained therewith are presented in Table 2.

In addition to the quantitative results presented in Table 2, a number of other observations were made and are reflected in the schematic depiction of FIG. 4. Specifically, as found in Example 1 above, when the droplet was place on the modified surface there was a linear flow in both directions (100). However, when the droplet was placed at the terminal point of the linear modification (110), flow was only observed in the direction of the modification. The lack of surface modification acted as a stop for flow. Similarly, when the droplet was placed at the intersection of the cross grating on the first pattern, but not on the cross grating itself, (120) flow into the cross grating was prevented whereas unidirectional flow along the path of the linear modification was observed. Although not depicted in FIG. 4, when the droplet was placed on the second pattern adjacent the cross grating, but not on the cross grating, again unidirectional flow was observed away from the cross grating. Finally, when the droplet was placed in the area of the cross grating flow was observed in all directions, up to 0.5 inch (1.27 cm), within the modified surface, but did not flow out of the modified area. These results show how the topography modification can be used to further direct flow with cross gratings and the like used to stop flow, separate a flow stream, etc.

TABLE 2

| | | | | | | Observed | |
|---|---|---|---|---|---|---|---|
| | | | | | Planar Surface | Linear | Observed |
| | | Frequency | | | Symmetrical | Fluid | Symmetri- |
| Sample | Pattern | μm | Amplitude | Fluid | Fluid Spread | Spread | cal Spread |
| 1 | Linear | 1.5 | 0.8 μm | A | 0.090 | 0.315 | |
| 2 | Cross | 1.5 × 1.5 | 0.8 μm | A | 0.090 | | 0.125 |
| 3 | Linear | 1.5 | 0.8 μm | B | 0.110 | 0.415 | |
| 4 | Cross | 1.5 × 1.5 | 0.8 μm | B | 0.110 | | 0.142 |
| 5 | Linear | 1.5 | 0.8 μm | C | 0.135 | 0.437 | |
| 6 | Cross | 1.5 × 1.5 | 0.8 μm | C | 0.135 | | 0.220 |
| 7 | Linear | 1.0 | 0.8 μm | A | 0.090 | 0.115 | |
| 8 | Cross | 1.0 × 1.0 | 0.8 μm | A | 0.090 | | 0.125 |
| 9 | Linear | 1.0 | 0.8 μm | B | 0.110 | 0.250 | |
| 10 | Cross | 1.0 × 1.0 | 0.8 μm | B | 0.110 | | 0.132 |
| 11 | Linear | 1.0 | 0.8 μm | C | 0.135 | 0.280 | |
| 12 | Cross | 1.0 ×1.0 | 0.8 μm | C | 0.135 | | 0.160 |

### Example 3

### Polymer Substrates

In order to demonstrate the applicability of the present invention to polymer films, especially with respect to the ability to transfer the surface topography, a number of polymer films were surface modified using the nickel shims from Example 1 as stamping tools. The transfer was effected by an embossing technique in which the heated nickel masters were heat pressed into the polymer film surface using a mechanical press. The heat of the press depended upon the softening point of the specific polymer films selected. Though not used here, the preferential method would be to use a hot rotary embossing process as this is a well known and effective process for embossing polymer films. The surfaces prepared and the results attained thereby are presented in Table 3. In Table 3, the polymer substrates are cyclic olefin copolymer (COC), polycarbonate (PC) and polyethylene terephthalate (PET). Other films being investigated include polyamide, ionomer resin (Surlyn™), polypropylene, polyethylene, high impact polystyrene and the like.

TABLE 3

| | | | | | Planar Surface | Observed | |
|---|---|---|---|---|---|---|---|
| | | Modulation | Modulation | | Symmetric Fluid | Linear Fluid | Net |
| Sample | Substrate | Frequency | Amplitude | Fluid | Spread | Spread | Effect |
| 1 | COC | 1.5 μm | 0.5 μm | A | 0.070 | 0.175 | 0.105 |
| 2 | COC | 1.5 μm | 0.5 μm | B | 0.080 | 0.220 | 0.140 |
| 3 | COC | 1.5 μm | 0.5 μm | C | 0.120 | 0.400 | 0.280 |
| 4 | PC | 1.5 μm | 0.5 μm | A | 0.070 | 0.125 | 0.055 |
| 5 | PC | 1.5 μm | 0.5 μm | B | 0.080 | 0.220 | 0.140 |
| 6 | PC | 1.5 μm | 0.5 μm | C | 0.120 | 0.310 | 0.190 |
| 7 | PET | 1.0 μm | 0.7 μm | A | 0.070 | 0.220 | 0.150 |
| 8 | PET | 1.0 μm | 0.7 μm | B | 0.080 | 0.280 | 0.200 |
| 9 | PET | 1.0 μm | 0.7 μm | C | 0.120 | 0.375 | 0.255 |

The results attained with the different polymers indicate the impact of surface energy on the manifestation of the desired flow. Similarly, as with the findings in Table 1, the selection of the fluid significantly influenced the manifestation of the effect of the surface topography on fluid flow. Reducing the surface tension within the fluid itself markedly increased fluid flow.

### Example 4

### Corona Treatment

As noted in Table 3 above, while the polymer films evaluated manifested the flow effect, they did so to a much lesser extent than the nickel substrates. It is believed that this is, at least in part, attributed to the surface energy characteristics of the polymer. In an effort to see the effect of a conventional surface modification technique, COC films made as in Example 3 and whose frequency of modulation was 1.5 μm and whose amplitude of modulation was 0.5 μm were corona treated to further alter the surface energy and profile characteristics. Corona treatment was effected by treating the polymer film surface with an Enercon corona treatment apparatus set to an output level of 0.7 Watt density. As a result of the treatment, the surface energy of the film was elevated to a level above 40 dyne/cm.

In comparing the flow effect with 1 μl of Deionized water of the corona treated and untreated films, it was observed that the symmetrical flow on the surface without the topographic modification increased from 0.070 inches to 0.130 inches. More importantly, the flow in the topographic modified sections increased from 0.175 inches to 0.305 inches. Interestingly, even though the whole of the film surface was treated, the fluid still manifested a linear flow and did not travel outside of the surface modulation flow paths.

While the present invention has been described with respect to aforementioned specific embodiments and examples, it should be appreciated that other embodiments utilizing the concept of the present invention are possible without departing from the scope of the invention. The present invention is defined by the claimed elements and any and all modifications, variations, or equivalents that fall within the spirit and scope of the underlying principles embraced or embodied thereby.

I claim:

1. A method of producing defined microfluidic flow properties on the surface of a substrate said method comprising (a) selecting a master device having a face, the surface of which (i) has one or more three dimensional images corresponding to the negative of one or more defined flow patterns to be imparted to the fluid conveying surface of substrate and (ii) is adapted to impart or transfer to that fluid conveying surface the positive of the one or more three dimensional images and (b) bringing said master device into contact with said fluid conveying surface so as to impart or transfer the one or more positive images corresponding to the one or more defined flow patterns to the fluid conveying surface, wherein said one or more three dimensional images comprise one or more defined flow paths characterized by a non-planer surface topography resulting from the presence of nano- or micro-scale surface alterations which surface alterations impart defined microfluidic flow properties to the surface of the substrate in the defined flow paths.

2. The method of claim 1 wherein the alteration in topography of the surface in the defined flow paths results in at least a 10% increase in the flow path surface area.

3. The method of claim 1 wherein the alteration in topography of the surface in the defined flow paths results in at least a 20% increase in the flow path surface area.

4. The method of claim 1 wherein the alteration in topography of the surface in the defined flow paths results in at least a 50% increase in the flow path surface area.

5. The method of claim 1 wherein the master device is a transfer roller and the transfer is effected by an embossing process, a heat and pressure imprinting process, or a heat curing process in the case of a substrate having a curable coating thereon.

6. The method of claim 1 wherein the master device is a stamp or die and the transfer or imparting of the topography is by stamping, with or without heat or pressure or both.

7. The method of claim 1 wherein the substrate is a stock material in sheet or roll form.

8. The method of claim 7 wherein the stock material is selected from a metal, metal foil, a polymer sheet, and a polymer film.

9. The method of claim 1 wherein the substrate surface is comprised of metal, metal foil, polymer, glass or ceramic and the master device capable of transferring the image the surface by way of a curable coating which is preapplied to the surface of the substrate or is applied to the surface by the master device wherein the coating is cured concurrent with or following the transfer of the image into the curable coating.

10. The method of claim 1 wherein multiple topographies are present in a single image, the multiple topographies providing different flow characteristics, including flow rate or the absence of flow, to different portions of the flow path or defining the bounds of the flow path or both.

11. The method of claim 1 wherein the substrate is the microfluidic surface of a microfluidic device.

12. The method of claim 1 wherein the surface alterations have an amplitude of up to 50 μm and a frequency or spacing of up to 500 μm.

13. The method of claim 1 wherein the surface alterations have an amplitude of from 100 nm to 25 μm and a frequency or spacing of from 100 nm to 250 μm.

14. The method of claim 1 wherein the surface alterations provide a corduroy-like effect to the surface of the defined flow paths whereby a cross-section of the flow path, perpendicular to the flow path, takes on the image of a sinusoidal wave pattern.

15. The method of claim 14 wherein the waves have an amplitude of from 100 nm to 10 μm and a frequency of from 300 nm to 15 μm.

16. The method of claim 1 further comprising the alteration of the substrate surface with a conventional fluid flow alteration treatment before, concurrent with or subsequent to the step of imparting or transferring the one or more images to the substrate surface; provided that when the conventional treatment is such as would destroy the nano- or micro-sized surface alterations, it is performed prior to imparting or transferring the surface topography to the substrate.

17. A substrate having one or more defined microfluidic flow paths on its surface said flow paths characterized as having a non-planar topography whereby the surface area of the substrate within the defined flow paths is increased by at least 10%, said topography providing directed flow characteristics as compared to surface areas free of such topography.

18. The substrate of claim 17 wherein the surface topography increases the surface area of the flow paths by at least 20%.

19. The substrate of claim 17 wherein the topography of the flow paths comprise a plurality of three dimensional nano- or micro-sized structures or both which structures having an amplitude of up to 50 μm and a frequency or spacing of up to 500 μm.

20. A substrate according to claim 17 wherein the substrate is a stock material in sheet or roll form and the substrate, has a plurality of repeated images corresponding to the one or more defined microfluidic flow paths.

21. The substrate of claim 20 wherein the stock material is a metal sheet, metal foil, polymer sheet or polymer film.

22. The substrate of claim 17 wherein the substrate or the surface of the substrate comprises a metal, metal foil, polymer, glass or ceramic.

23. The substrate of claim 17 wherein the surface has also been subjected to a conventional fluid flow alteration treatment.

24. The substrate of claim 23 wherein the conventional fluid flow alteration treatment is selected from channels wherein the non-planar topography is applied to the floor or walls or both of the channels, plasma or corona treatments, and the application of coatings or treatments which alters the hydrophilicity of the substrate or applies a different hydrophilicity or hydrophobicity to the treated surface.

25. The substrate of claim 17 wherein the surface alterations provide a corduroy-like effect to the surface of the defined flow paths whereby a cross-section of the flow path, perpendicular to the flow path, takes on the image of a sinusoidal wave pattern.

26. The substrate of claim 17 wherein multiple topographies are present in a single flow path, the multiple topographies providing different flow characteristics, including flow rate or the absence of flow, to different portions of the flow path or defining the bounds of the flow path or both.

27. A substrate which possesses microfluidic properties and control on its surface, said substrate made in accordance with the method of claim 1.

28. A microfluidic device whose surface upon which microfluidic flow is manifested is made in accordance with the method of claim 1.

29. The microfluidic device of claim 28 which is a lateral flow device.

30. The microfluidic device of claim 28 which is not a lateral flow device.

31. A method of imparting defined and controlled microfluidic flow to the surface of a substrate, said method comprising the formation of one or more defined flow paths on the substrate surface, the defined flow paths characterized by a non-planar topography comprising three dimensional structures which increase the surface area of the substrate in the defined flow paths by at least 10%.

32. The method of claim 31 wherein the increase in surface area is at least 20%.

33. The method of claim 31 wherein said three dimensional structures have an amplitude of up to 50 μm and a frequency or spacing of up to 500 μm.

34. The method of claim 31 wherein the topography provides a corduroy-like effect to the surface of the defined flow paths whereby a cross-section of the flow path, perpendicular to the flow path, takes on the image of a sinusoidal wave pattern.

35. The method of claim 31 wherein multiple topographies are present in the flow path, the multiple topographies providing different flow characteristics, including flow rate or the absence of flow, to different portions of the flow path or defining the bounds of the flow path or both.
